(19) United States
(12) Patent Application Publication
(10) Pub. No.: US 2026/0261839 A1
(43) Pub. Date: Sep. 3, 2026

(54) SYSTEM AND METHOD FOR ENHANCED CHANGE HANDLING OF A PUBLIC LAND MOBILE NETWORK

(71) Applicant: JIO PLATFORMS LIMITED, Ahmedabad (IN)

(72) Inventors: Aditya GUPTA, Kamal (IN); Mukta SHETTY, Thane (IN); Apoorva KHAMESRA, Udaipur (IN); Durgesh GANESH, Birtamode (NP); Sayali Bhaskar JADHAV, Nashik (IN); Anjali KUNUGUNTLA, Lingala Village, Vatsavai Mandal (IN)

(73) Assignee: JIO PLATFORMS LIMITED, Ahmedabad (IN)

(21) Appl. No.: 18/873,420

(22) PCT Filed: Jun. 29, 2023
(86) PCT No.: PCT/IB2023/056779

§ 371 Date: Dec. 10, 2024

(30) Foreign Application Priority Data
Jun. 29, 2022 (IN) 202221037377

(51) Int. Cl. H04W 8/12; H04W 76/10; H04W 84/04

(52) U.S. Cl. CPC H04W 8/12; H04W 76/10; H04W 84/042

(57) ABSTRACT

The present disclosure provides a system and a method for enhanced change handing of a public land mobile network (PLMN). The system receives a request from users, where the request is based on a protocol data unit (PDU) session initiated by the users. The system establishes a session management (SM) policy based on the request and sends the SM policy to a control plane function to dynamically control one or more network resources based on one or more predefined business rules. Further, the system initiates a communication between the users and an application function (AF) based on the one or more network resources. The system validates the predefined business rules based on the communication between the users and the AF.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for wireless telecommunication systems. More particularly, the present disclosure relates to a system and a method for enhanced change handling of a public land mobile network (PLMN).

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Generally, a public land mobile network (PLMN) may be network established and operated by an administration or a network operator for a specific purpose of providing land mobile communication services to the public. The PLMN may provide communication possibilities for mobile users. The PLMN may provide service in one or a combination of frequency bands where a relationship exists between each subscriber and a Home PLMN (HPLMN) of the respective subscriber. If communications are handled over another PLMN, then the PLMN is referred to as a Visited PLMN (VPLMN). A PLMN area is the geographical area in which the PLMN provides communication services according to the specifications corresponding to mobile users. In the PLMN area, mobile users can set up calls to other users of a terminating network. The terminating network may be a fixed network, the same PLMN, another PLMN, or other types of PLMN. Terminating network users can also set up calls to the PLMN. The PLMN area is allocated to the PLMN, which is determined by the service provider. Further, in a fifth generation (5G)/5G core new radio (NR), an access and mobility policy control by an access and mobility management function (AMF) may encompass management of service area restrictions and management of a radio access technology (RAT) frequency selection priority (RFSP) functionalities. The management of service area restrictions enables a policy control function (PCF) to modify the service area restrictions used by the AMF. The user equipments' (UEs') subscription may contain service area restrictions, which may further be modified by the PCF based on the network operator-defined policies at any time. The modification may be performed either by expanding a list of allowed tracking area identities (TAIs) or by reducing non-allowed TAIs, or increasing the maximum number of allowed TAIs. Further, the network operator-defined policies in the PCF may depend on input data such as a UE location, time of day, the information provided by other network functions (NFs), and the like. Further, a session management subscription data for a subscription permanent identifier (SUPI) may be queried by a session management function (SMF) during a session setup, using query parameters representing the selected network slice and a data network name (DNN). The SMF may be responsible for enforcing the user session management subscription data.

However, there may be a problem for releasing of multiple sessions for a same SUPI based on a single update received from the SMF. It may be required that all session management sessions for the SUPI may need to be released at the same time. Further, for an internet protocol multimedia subsystem (IMS) DNN, the PCF may not wait for a call to end before sending a terminate notification. Further, the PCF may be required to enhance actions to control the behaviour of multiple sessions for the same SUPI or only to release a specific session. Further, there may be a need for the possibility to release the access and mobility (AM) session.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method for enhanced change handling of a public land mobile network (PLMN).

It is an object of the present disclosure to enhance policies in a policy control function (PCF) by providing flexibility to identify, such as international vs national roaming, whether a call is ongoing or not during a PLMN change, and legal requirements.

It is an object of the present disclosure to enable the PCF to identify a call continuity for single or multiple sessions for the same subscription permanent identifier (SUPI).

It is an object of the present disclosure to enable the PCF to take specific actions such as a release session for all the sessions related to the SUPI or a single session for an update received from a session management function (SMF).

It is an object of the present disclosure to enable the PCF to take action to release the access and mobility (AM) session for the SUPI based on the SUPI presence on the PCF.

It is an object of the present disclosure to enable the PCF to wait until a call is terminated before sending the action such as a “Terminate Notify” towards the SMF for a particular session.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to enhanced change handling of a public land mobile network (PLMN). The system includes a processor, and a memory operatively coupled to the processor, where the memory stores instructions to be executed by the processor. The processor receives a request from a computing device associated with one or more users. The request is based on a protocol data unit (PDU) session initiated by the one or more users. The processor establishes a session management (SM) policy based on the request. The processor transmits the SM policy to a control plane function to dynamically control one or more network resources based on one or more predefined rules. The processor initiates a communication between the computing device associated with the one or more users and an application function (AF) based on the one or more network resources. The processor receives an update from the control plane function on the SM policy based on a roaming status of the computing device associated with the one or more users. The processor determines if the communication between the computing device and the AF exists based on validation of the one or more predefined rules and the roaming status of the computing device.

In an embodiment, the processor may wait for a simultaneous transmit receive (STR) notification from the AF to determine if the communication between the computing device and the AF exists.

In an embodiment, the processor may, in response to a positive determination, maintain the communication between the computing device associated with the one or more users and the AF.

In an embodiment, the processor may, in response to a negative determination, terminate sending of the SM policy to the control plane function.

In an embodiment, the control plane function may be a session management function (SMF).

In an embodiment, the AF may be a call session control function (CSCF).

In an embodiment, the processor may receive the update from the control plane function via a PLMN channel.

In an embodiment, the processor may receive a subscriber permanent identifier (SUPI) from the control plane function and establish the communication between the computing device associated with the one or more users and the AF based on the SUPI.

In an embodiment, the processor may terminate transmitting an acknowledge mode (AM) policy association to an access and mobility management function (AMF) based on a negative determination.

In an embodiment, the processor may transmit a SM policy terminate notification to the control plane function and an AM policy terminate notification to the AF based on a negative determination.

In an embodiment, the one or more predefined rules may include at least one of a RxSessionCheck, a OnGoingCallOnPLMN, and a SMFAction.

In an aspect, the present disclosure relates to a method for enhanced change handling of a PLMN. The method includes receiving, by a processor associated with a system, a request from a computing device associated with one or more users. The request is based on a PDU session initiated by the one or more users. The method includes establishing, by the processor, a SM policy based on the request. The method includes transmitting, by the processor, the SM policy to a control plane function to dynamically control one or more network resources based on one or more predefined rules. The method includes initiating, by the processor, a communication between the computing device associated with the one or more users and an AF based on the one or more network resources. The method includes receiving, by the processor, an update from the control plane function on the SM policy based on a roaming status of the computing device associated with the one or more users. The method includes determining, by the processor, if the communication between the computing device and the AF exists based on validation of the one or more predefined rules and the roaming status of the computing device.

In an embodiment, the method may include waiting, by the processor, for a STR notification from the AF to determine if the communication between the computing device and the AF exists.

In an embodiment, the method may include maintaining, by the processor, the communication between the computing device associated with the one or more users and the AF in response to a positive determination.

In an embodiment, the method may include terminating, by the processor, sending the SM policy to the control plane function in response to a negative determination.

In an embodiment, the method may include receiving, by the processor, the update from the control plane function via a PLMN channel.

In an embodiment, the method may include receiving, by the processor, a SUPI from the control plane function and establishing the communication between the computing device associated with the one or more users and the AF based on the SUPI.

In an embodiment, the method may include termination of transmission, by the processor, an AM policy to an AMF based on a negative determination.

In an embodiment, the method may include transmitting, by the processor, a SM policy terminate notification to the control plane function and an AM policy terminate notification to the AF based on a negative determination.

In an aspect, a user equipment (UE) for sending requests includes one or more processors communicatively coupled to a processor in a system. The one or more processors are coupled with a memory and said memory stores instructions to be executed by the one or more processors. The one or more processors transmit a request to the processor via a network. The request is based on a PDU session initiated by UE associated with one or more users. The processor is configured to receive the request from the UE. The processor is configured to establish a SM policy based on the request from the UE. The processor is configured to send the SM policy to a control plane function to dynamically control one or more network resources based on one or more predefined rules. The processor is configured to initiate a communication between the UE and an application function based on the one or more network resources. The processor is configured to receive an update from the control plane function on the SM policy based on a roaming status of the one or more users. The processor is configured to determine if the communication between the UE and the AF exists based on validation of the one or more predefined rules and the roaming status of the UE.

In an aspect, a non-transitory computer readable medium includes a processor with executable instructions that cause the processor to receive a request from a computing device associated with one or more users. The request is based is based on a PDU session initiated by the one or more users. The processor establishes a SM policy based on the request. The processor transmits the SM policy to a control plane function to dynamically control one or more network resources based on one or more predefined rules. The processor initiates a communication between the one or more users and an AF based on the one or more network resources. The processor receives an update from the control plane function on the SM policy based on a roaming status of the computing device associated with the one or more users. The processor determines if the communication between the computing device and the AF exists based on validation of the one or more predefined rules and the roaming status of the computing device.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture (100) for implementing a proposed system (108), in accordance with an embodiment of the present disclosure.

FIG. 2 illustrates an example block diagram (200) of a proposed system (108), in accordance with an embodiment of the present disclosure.

FIG. 3 illustrates an example flow diagram (300) for enhanced change handling of a public land mobile network (PLMN), in accordance with an embodiment of the present disclosure.

FIG. 4 illustrates an example computer system (400) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

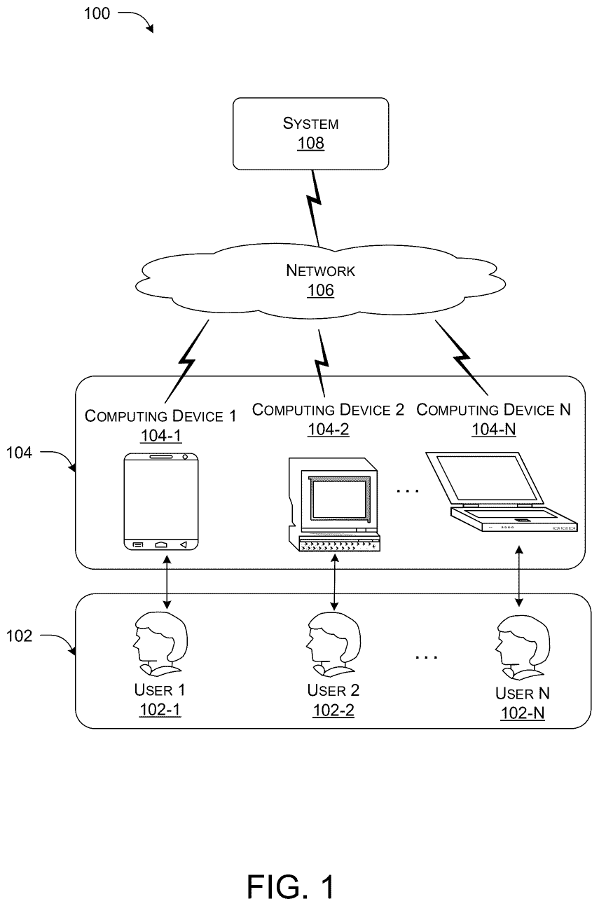

The various embodiments throughout the disclosure will be explained in more detail with reference to FIGS. 1-4.

FIG. 1 illustrates an example network architecture (100) for implementing a proposed system (108), in accordance with an embodiment of the present disclosure.

As illustrated in FIG. 1, the network architecture (100) may include a system (108). The system (108) may be connected to one or more computing devices (104-1, 104-2 . . . 104-N) via a network (106). The one or more computing devices (104-1, 104-2 . . . 104-N) may be interchangeably specified as a user equipment (UE) (104) and be operated by one or more users (102-1, 102-2 . . . 102-N). Further, the one or more users (102-1, 102-2 . . . 102-N) may be interchangeably referred as a user (102) or users (102). In an embodiment, the system (108) may be interchangeably referred as a policy control function (PCF).

In an embodiment, the computing devices (104) may include, but not be limited to, a mobile, a laptop, etc. Further, the computing devices (104) may include a smartphone, virtual reality (VR) devices, augmented reality (AR) devices, a general-purpose computer, desktop, personal digital assistant, tablet computer, and a mainframe computer. Additionally, input devices for receiving input from the user (102) such as a touch pad, touch-enabled screen, electronic pen, and the like may be used. A person of ordinary skill in the art will appreciate that the computing devices (104) may not be restricted to the mentioned devices and various other devices may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) may receive a request from the computing device (104) associated with the one or more users (102). The request may be based on a protocol data unit (PDU) session initiated by the one or more users (102). The system (108) may establish a session management (SM) policy based on the request. The system (108) may transmit the SM policy to a control plane function i.e., to dynamically control one or more network resources based on one or more predefined business rules. The control plane function may be a session management function (SMF). The one or more predefined business rules may include, but not limited to, a RxSessionCheck, a OnGoingCallOnPLMN, and a SMFAction.

In an embodiment, the system (108) may initiate a communication between the computing device (104) and an application function (AF) based on the one or more network resources. The AF may be a call session control function (CSCF)

In an embodiment, the system (108) may receive an update from the control plane function on the SM policy based on a roaming status of the computing device (104) associated with the one or more users (102). The system (108) may receive the update from the control plane function via a public land mobile network (PLMN) channel. The system (108) may receive a subscriber permanent identifier (SUPI) from the control plane function and establish the communication between the computing device (104) associated with the one or more users (102) and the AF.

In an embodiment, the system (108) may determine if the communication between the computing device (104) and the AF exists based on validation of the one or more predefined rules and the roaming status of the computing device (104). The system (108) may wait for a simultaneous transmit receive (STR) notification from the AF to determine if the communication between the computing device (104) and the AF exists.

In an embodiment, the system (108) may in response to a positive determination, maintain the communication between the computing device (104) associated with the one or more users (102) and the AF.

In an embodiment, the system (108) may terminate transmitting an acknowledge mode (AM) policy to an access and mobility management function (AMF) based on a negative determination. The system (108) may in response to a negative determination, terminate sending of the SM policy to the control plane function. Further, the system (108) may transmit a SM policy terminate notification to the control plane function and an acknowledge mode (AM) policy terminate notification to the AF based on a negative determination.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

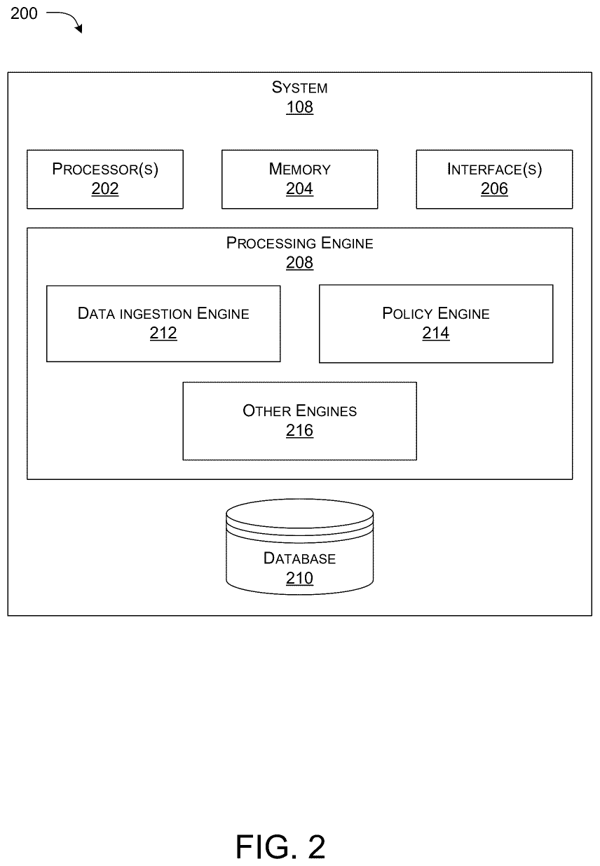

FIG. 2 illustrates an example block diagram (200) of a proposed system (108), in accordance with an embodiment of the present disclosure.

Referring to FIG. 2, the system (108) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (108). Examples of such components include, but are not limited to, processing engine(s) (208) and a database (210), where the processing engine(s) (208) may include, but not be limited to, a data ingestion engine (212), a policy engine (214), and other engine(s) (216). In an embodiment, the other engine(s) (216) may include, but not limited to, a data management engine, an input/output engine, and a notification engine.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (208) may be implemented by electronic circuitry.

In an embodiment, the processor (202) may receive a request via the data ingestion engine (212). The request may be received from a computing device associated with one or more users (102). The processor (202) may store the request in the database (210). The request may be based on a PDU session initiated by the one or more users (102). The processor (202) may establish a SM policy based on the request. The processor (202) may send the SM policy to a control plane function to dynamically control one or more network resources based on one or more predefined rules. The one or more predefined business rules may include at least one of a RxSessionCheck, a OnGoingCallOnPLMN, and a SMFAction.

In an embodiment, the processor (202) may initiate a communication between the computing device (104) and an application function (AF) based on the one or more network resources. The AF may be a call session control function (CSCF)

In an embodiment, the processor (202) may receive an update from the control plane function via the policy engine (214) on the SM policy based on a roaming status of the computing device (104) associated with the one or more users (102). The processor (202) may receive the update from the control plane function via a public land mobile network (PLMN) channel. Further, the processor (202) may receive a subscriber permanent identifier (SUPI) from the control plane function and establish the communication between the computing device (104) associated with the one or more users (102) and the AF.

In an embodiment, the processor (202) may determine if the communication between the computing device (104) and the AF exists based on validation of the one or more predefined rules and the roaming status of the computing device (104). The processor (202) may wait for a simultaneous transmit receive (STR) notification from the AF to determine if the communication between the computing device (104) and the AF exists.

In an embodiment, the processor (202) may in response to a positive determination, maintain the communication between the computing device (104) associated with the one or more users (102) and the AF.

In an embodiment, the processor (202) may terminate transmitting an acknowledge mode (AM) policy to an access and mobility management function (AMF) based on a negative determination. The processor (202) may in response to a negative determination, terminate sending of the SM policy to the control plane function. Further, the processor (202) may transmit a SM policy terminate notification to the control plane function and an acknowledge mode (AM) policy terminate notification to the AF based on a negative determination.

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

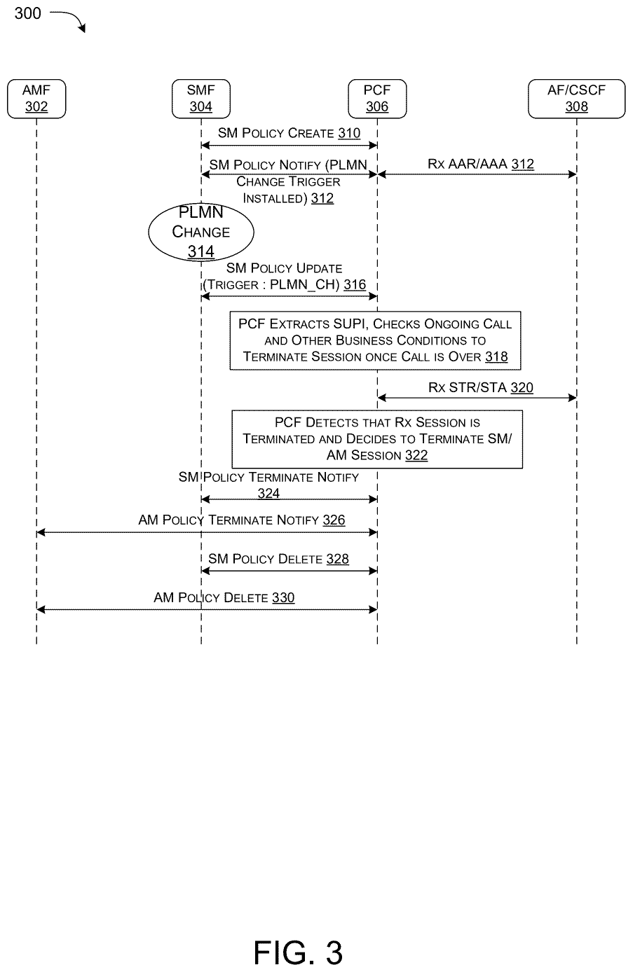

FIG. 3 illustrates an example flow diagram (300) for enhanced change handling of PLMN, in accordance with an embodiment of the present disclosure.

As illustrated in FIG. 3, the following steps may be implemented.

At step 310: A SM policy may be created across SMF (304) and PCF (306).

At step 312: A SM policy may be established across the SMF (304) and the PCF (306). Further, an Rx authorization authentication request/authentication authorization, and accounting (AAR/AAA) may be established across the PCF (306) and AF/CSCF (308).

At step 314: A PLMN change may be initiated at the SMF (304).

At step 316: The SM policy may be updated across the SMF (304) and the PCF (306).

At step 318: The PCF (306) may extract SUPI and check ongoing calls, business conditions for terminating a session once the call is over.

At step 320: An Rx session terminate request/session terminate answer (STR/STA) may be established across the PCF (306) and the AF/CSCF (308).

At step 322: The PCF (306) may detect that the Rx session is terminated and may decide to terminate the SM/AM session.

At step 324: A SM policy terminate notify may be established across the SMF (304) and the PCF (306).

At step 326: An AM policy terminate notify may be established across an AMF (302), the SMF (304), and the PCF (306).

At step 328: A SM policy delete may be established across the SMF (304) and the PCF (306).

At step 330: An AM policy delete may be established across the AMF (302), the SMF (304), and the PCF (306).

In an embodiment, the AM session may be already established with same PCF (306). Based on a UE (104)/network (106) initiated PDU session establishment procedure, results in the SM policy association may be established at the PCF (306). Further, a PLMN_CH trigger may be installed during establishment of a session or during the notify procedure.

In an embodiment, the Rx session may be created at the PCF (306) based on a call set up by the user (102). The PCF (306) may send the SM policy notify message to the SMF (304) to install a policy and charging control (PCC) rule based on media components as per business rules defined in the PCF (306).

In an embodiment, the UE (104) may change the PLMN during mobility, which may result in the SMF (304) sending the SM policy update message with PLMN_CH trigger. Further, the PCF (306) may validate the business rule condition including a condition to check if the call is still ongoing through the Rx session. Other business conditions may also be checked as defined by the PCF (306). The PCF (306) may decide to terminate the SM and AM policy association when the ongoing call finishes. Further, once the ongoing call finishes, the STR may be sent from the AF/CSCF (308) to close the Rx session.

In an embodiment, the PCF (306) may identify that the ongoing call has finished and may decide to terminate the AM/SM policy associations for the SUPI. Further, the PCF (306) may send SM policy terminate notify message towards the SMF (304) and the AM policy terminate notify message towards AMF (302). The AMF (302) and the SMF (304) may send the AM policy delete and the SM policy delete messages, respectively, closing the PDU session.

In an embodiment, the system (108) may introduce a new parameter known such as an “RxSessionCheck” with an operator support for drop down with “Exists” or “Not Exist” and a term supporting drop down for “AllSessions” or “SingleSession.” This condition may provide enhancement to the user (102) so that for an incoming SM update message, the user (102) may be able to check if there exists an Rx for a current SM Session or all the SM sessions.

In an embodiment, the system (108) may provide an “OnGoingCallOnPLMN” rule type for the PLMN to identify if the Rx session corresponding to the received SM session is present. Further, the system (108) may determine if the Rx session is allowed to be continued or not, if the Rx session corresponding to the received SM session is present. In case the Rx session is “NotAllowed” to be continued, further action such as “Terminate Notify” may be transmitted immediately to the PLMN with “Allowed” case. Further, the system (108) may wait until the call is terminated before transmitting the “TerminateNotify” action. In an embodiment, the “TerminateNotify” action may be used for sending the Terminate Notify message towards the SMF (304) for the session in question. The SMF (304) action rule type may be provided with action “Trigger” and rule as “TerminateNotify.”

For the rule type “OnGoingCallOnPLMN,” support may be provided for rule “Allowed” and “NotAllowed.” The rule may be enhanced to provide the support for “AllAllowed” (drop-down may include Allowed/NotAllowed/AllAllowed). This action may enable to check the Rx Session, not only for SM session for which message may be received but also for any other session for a same SUPI. For rule type “SMFAction,” action “Trigger,” rule “TerminateNotify” may be supported. In addition to the rule TerminateNotify,” a “TerminateNotifyAll” may also need to be supported (drop-down may include TerminateNotify/TerminateNotifyAll). The new rule (TerminateNotifyAll) may be used to send a Terminate Notify message for all existing sessions for the SUPI for which rule is being analysed. For SM sessions, if two SM update requests are received by the system (108) for same SUPI for which rule (same or different) are triggered with Terminate Notify All action, then the system (108) may need to consider first rule for sending the Terminate Notify to avoid race around condition.

In an instance, the system (108) may be able to identify the call continuity for single or all sessions for a same SUPI. Further, based on identification, the system (108) may be able to take specific actions such as release session for either all the sessions related to the SUPI or release a single session for which an update may be received from the SMF (304). Also, the system (108) may be able to take action to release the AM session for the SUPI in case the AM session is present on the system (108). For the PCC rule, the system (108) may introduce a new parameter in a left term as “RxSessionCheck” with a network operator support for drop-down with “exists” or “not exist” and a right term supporting drop down for “AllSessions” or “SingleSession.” This condition may enable enhanced change handling of the PLMN, so that for an incoming SM update message, the system (108) may check if there is existing Rx for current SM session (Single Session) or for all SM session associated with the SUPI (AllSessions).

For example, consider that an AM session for a SUPI may exist on a same system (108)/PCF (306), which is currently handling a SM session. For a scenario where a call is allowed, the PCF (306) may only check the ongoing call at the time of evaluating the above rules. If the terminate action is selected during evaluation, and/or post evaluation during the ongoing call, a new AF/Rx session may be established. The AF/Rx may not be considered as part of the ongoing call. Further, as part of action, the PCF (306) may support sending the AM session terminate with user-configurable cause. If this action is selected in the rule, then the PCF (306) may search for the AM session for corresponding SUPI in the same PCF (306). If the AM session is found in PCF (306), the PCF (306) may send the Terminate Notify action towards an AMF (302). Further, if AM session does not exist, then the PCF (306) may not send Terminate Notify. The PCF (306) may continue processing rule by bypassing the AM Terminate Notify action. To send the AM Terminate Notify action, the system (108) may consider below scenarios:
For case when OnGoingCallOnPLMN is Allowed/AllowedAll is included in the rule, the AM Session Terminate may be sent once the calls for the associated SUPI are terminated.
For case when TerminateNotify/TerminateNotifyAll action for SM is included in the rule, AM session terminate may be sent after the Terminate Notify action for SM sessions has been sent.
For any other case, AM Terminate Notify may be sent immediately.
For AM session, terminate the action if the ongoing call is allowed or SM Terminate Notify is included in the rule, there may be a scenario that, for the time call is ongoing another update from the SMF (304). This may trigger another or the same rule which calls for AM Session Terminate action. In this case, PCF (306) may not try to trigger AM Terminate for both rule triggers. The PCF (306) may trigger the AM Terminate based on the first rule match.

For sessions, the behaviour may be defined in Table 1 below for various combinations for SM action and Ongoing call:

TABLE 1

| | SMFAction | |
|---|---|---|
| OnGoingCallOnPLMN | (Trigger) | Description |
| Not | TerminateNotify | Immediately send the Terminate notify |
| Present/NotAllowed | | for the Session for which the rule is |
| | | being evaluated |
| Not | TerminateNotifyAll | Immediately send the Terminate Notify |
| Present//NotAllowed | | for all the SM sessions for SUPI for |
| | | which the rule is being evaluated. |
| Allowed | TerminateNotify | For current SM session for which the |
| | | rule is being evaluated, check if |
| | | corresponding Rx session/ Policy |
| | | Authorization exists (Call is Ongoing). If |
| | | the same exists, put the session in table |
| | | and keep session live till the Call is not |
| | | terminated. Once Call is terminated, |
| | | send the Terminate Notify. If the call is |
| | | not Ongoing, send the Terminate Notify |
| | | message to the SMF (304). |
| Allowed | TerminateNotifyAll | For current SM session of SUPI for |
| | | which Rule is being evaluated, check if |
| | | corresponding Rx session/ Policy |
| | | Authorization exists (Call is Ongoing). If |
| | | the same exists (for current SM Session |
| | | only), place all the sessions for the SUPI |
| | | in question in a table and keep all SM |
| | | sessions alive till call is not terminated. |
| | | Once call is terminated send Terminate |
| | | Notify for not only the current Session |
| | | but all SM sessions corresponding to the |
| | | SUPI. Please note that Terminate Notify |
| | | for all applicable SM Sessions should be |
| | | sent together once the call is finished. |
| | | (i.e. it shouldn't be case that Terminate |
| | | for network was sent before call got |
| | | finished for session under internet |
| | | protocol multimedia subsystem-data |
| | | network name (IMS-DNN) |
| NotAllowed | TerminateNotify | For SM Session for which Rule is being |
| | | evaluated, send the terminate Notify |
| | | immediately. |
| NotAllowed | TerminateNotifyAll | Immediately send Terminate Notify for |
| | | all SM sessions corresponding to SUPI |
| | | for which rule is being evaluated |
| | | (irrespective of fact whether call is |
| | | ongoing or not in other sessions). |
| AllowedAll | TerminateNotify | For all SM session related to SUPI, |
| | | check if corresponding Rx session/ |
| | | Policy Authorization exists (Call is |
| | | Ongoing). If the same exists, put the |
| | | session in table and keep session live till |
| | | the Call is not terminated. Once Call is |
| | | terminated, send the Terminate Notify |
| | | for this session only. If the call is not |
| | | Ongoing, send the Terminate Notify |
| | | message to SMF for this session only. |
| AllowedAll | TerminateNotifyAll | For all SM sessions of SUPI for which |
| | | Rule is being evaluated, check if for any |
| | | one of them corresponding Rx session/ |
| | | Policy Authorization exists (Call is |
| | | Ongoing). If the same exists (for same |
| | | SUPI but could be same or different |
| | | session), put all the sessions for the |
| | | SUPI in question in table and keep all |
| | | SM sessions alive till call is not |
| | | terminated. Once call is terminated send |
| | | Terminate Notify for not only current |
| | | Session and but all SM sessions |
| | | corresponding to the SUPI. Please note |
| | | that Terminate Notify for all applicable |
| | | SM Sessions should be sent together |
| | | once call is finished. (i.e. it shouldn't be |
| | | case that Terminate for network was sent |
| | | before call got finished for session under |
| | | IMS-DNN) |

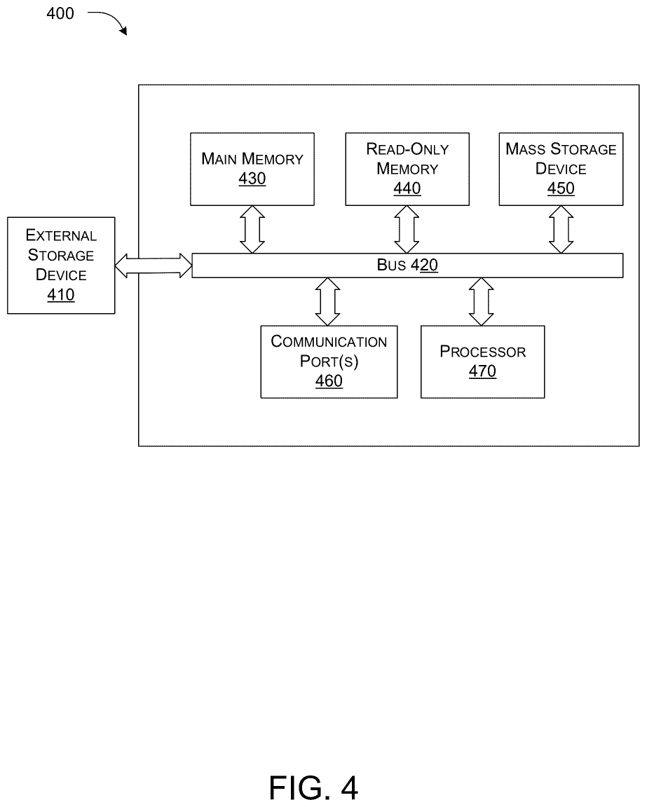

FIG. 4 illustrates an exemplary computer system (400) in which or with which embodiments of the present disclosure may be implemented.

As shown in FIG. 4, the computer system (400) may include an external storage device (410), a bus (420), a main memory (430), a read-only memory (440), a mass storage device (450), a communication port(s) (460), and a processor (470). A person skilled in the art will appreciate that the computer system (400) may include more than one processor and communication ports. The processor (470) may include various modules associated with embodiments of the present disclosure. The communication port(s) (460) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (460) may be chosen depending on a network, such as a Local Area Network (LAN), Wide Area Network (WAN), or any network to which the computer system (400) connects.

In an embodiment, the main memory (430) may be Random Access Memory (RAM), or any other dynamic storage device commonly known in the art. The read-only memory (440) may be any static storage device(s) e.g., but not limited to, a Programmable Read Only Memory (PROM) chip for storing static information e.g., start-up or basic input/output system (BIOS) instructions for the processor (470). The mass storage device (450) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (420) may communicatively couple the processor(s) (470) with the other memory, storage, and communication blocks. The bus (420) may be, e.g. a Peripheral Component Interconnect PCI)/PCI Extended (PCI-X) bus, Small Computer System Interface (SCSI), (USB), or the like, for connecting expansion cards, drives, and other subsystems as well as other buses, such a front side bus (FSB), which connects the processor (470) to the computer system (400).

In another embodiment, operator and administrative interfaces, e.g., a display, keyboard, and cursor control device may also be coupled to the bus (420) to support direct operator interaction with the computer system (400). Other operator and administrative interfaces can be provided through network connections connected through the communication port(s) (460). Components described above are meant only to exemplify various possibilities. In no way should the aforementioned exemplary computer system (400) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method for enhanced change handling of a public land mobile network (PLMN).

The present disclosure provides a system and a method to enhance policies in a policy control function (PCF) by providing flexibility to identify, such as international vs national roaming, whether a call is ongoing or not during a PLMN change, and legal requirements.

The present disclosure provides a system and a method to enable the PCF to identify a call continuity for a single or multiple sessions for the same subscription permanent identifier (SUPI).

The present disclosure provides a system and a method to enable the PCF to take specific actions such as a release session for all the sessions related to the SUPI or a single session for an update received from a session management function (SMF).

The present disclosure provides a system and a method to enable the PCF to take action to release the access and mobility (AM) session for the SUPI based on the SUPI presence on the PCF.

The present disclosure provides a system and a method to enable the PCF to wait until a call is terminated before sending the action such as a “Terminate Notify” towards the SMF for a particular session.

1. A system for enhanced change handling of a public land mobile network (PLMN), the system comprising:
a processor; and
a memory operatively coupled with the processor, wherein said memory stores instructions which, when executed by the processor, cause the processor to:
receive a request from a computing device associated with one or more users, wherein the request is based on a protocol data unit (PDU) session initiated by the one or more users;
establish a session management (SM) policy based on the request;
transmit the SM policy to a control plane function to dynamically control one or more network resources based on one or more predefined rules;
initiate a communication between the computing device associated with the one or more users and an application function (AF) based on the one or more network resources;
receive an update from the control plane function on the SM policy based on a roaming status of the computing device associated with the one or more users; and
determine if the communication between the computing device and the AF exists based on validation of the one or more predefined rules and the roaming status of the computing device.

2. The system as claimed in claim 1, wherein the processor is to wait for a simultaneous transmit receive (STR) notification from the AF to determine if the communication between the computing device and the AF exists.

3. The system as claimed in claim 1, wherein the processor is to, in response to a positive determination, maintain the communication between the computing device associated with the one or more users and the AF.

4. The system as claimed in claim 1, wherein the processor is to, in response to a negative determination, terminate sending of the SM policy to the control plane function.

5. The system as claimed in claim 1, wherein the control plane function is a session management function (SMF).

6. The system as claimed in claim 1, wherein the AF is a call session control function (CSCF).

7. The system as claimed in claim 1, wherein the processor is to receive the update from the control plane function via a PLMN channel.

8. The system as claimed in claim 1, wherein the processor is to receive a subscriber permanent identifier (SUPI) from the control plane function and establish the communication between the computing device associated with the one or more users and the AF based on the SUPI.

9. The system as claimed in claim 1, wherein the processor is to terminate transmitting an acknowledge mode (AM) policy to an access and mobility management function (AMF) based on a negative determination.

10. The system as claimed in claim 1, wherein the processor is to transmit a SM policy terminate notification to the control plane function and an acknowledge mode (AM) policy terminate notification to the AF based on a negative determination.

11. The system as claimed in claim 1, wherein the one or more predefined rules comprise at least one of: a RxSessionCheck, a OnGoingCallOnPLMN, and a SMFAction.

12. A method for enhanced change handling of a public land mobile network (PLMN), the method comprising:
receiving, by a processor associated with a system, a request from a computing device associated with one or more users, wherein the request is based on a protocol data unit (PDU) session initiated by the one or more users;
establishing, by the processor, a session management (SM) policy based on the request;
transmitting, by the processor, the SM policy to a control plane function to dynamically control one or more network resources based on one or more predefined rules;
initiating, by the processor, a communication between the computing device associated with the one or more users and an application function (AF) based on the one or more network resources;
receiving, by the processor, an update from the control plane function on the SM policy based on a roaming status of the computing device associated with the one or more users; and
determining, by the processor, if the communication between the computing device and the AF exists based on validation of the one or more predefined rules and the roaming status of the computing device.

13. The method as claimed in claim 12, comprising waiting, by the processor, for a simultaneous transmit receive (STR) notification from the AF to determine if the communication between the computing device and the AF exists.

14. The method as claimed in claim 12, comprising maintaining, by the processor, the communication between the computing device associated with the one or more users and the AF in response to a positive determination.

15. The method as claimed in claim 12, comprising terminating, by the processor, sending the SM policy to the control plane function in response to a negative determination.

16. The method as claimed in claim 12, comprising receiving, by the processor, the update from the control plane function via a public land mobile network (PLMN) channel.

17. The method as claimed in claim 12, comprising receiving, by the processor, a SUPI from the control plane function and establishing the communication between the computing device associated with the one or more users and the AF based on the SUPI.

18. The method as claimed in claim 12, comprising termination of transmission, by the processor, an acknowledge mode (AM) policy to an access and mobility management function (AMF) based on a negative determination.

19. The method as claimed in claim 12, comprising transmitting, by the processor, a SM policy terminate notification to the control plane function and an acknowledge mode (AM) policy terminate notification to the AF based on a negative determination.

20. A user equipment (UE) for sending requests, the UE comprising:
one or more processors communicatively coupled to a processor associated with a system, wherein the one or more processors are coupled with a memory, and wherein said memory stores instructions which, when executed by the one or more processors, cause the one or more processors to:
transmit a request to the processor via a network, wherein the request is based on a protocol data unit (PDU) session initiated by the UE associated with one or more users, wherein the processor is configured to:
receive the request from the UE;
establish a session management (SM) policy based on the request from the UE;
transmit the SM policy to a control plane function to dynamically control one or more network resources based on one or more predefined rules;
initiate a communication between the UE associated with the one or more users and an application function (AF) based on the one or more network resources;
receive an update from the control plane function on the SM policy based on a roaming status of the UE associated with the one or more users; and
determine if the communication between the UE and the AF exists based on validation of the one or more predefined rules and the roaming status of the UE.

21. A non-transitory computer readable medium comprising a processor with executable instructions, causing the processor to:
receive a request from a computing device associated with one or more users, wherein the request is based on a protocol data unit (PDU) session initiated by the one or more users;
establish a session management (SM) policy based on the request;
transmit the SM policy to a control plane function to dynamically control one or more network resources based on one or more predefined rules;
initiate a communication between the computing device associated with the one or more users and an application function (AF) based on the one or more network resources;
receive an update from the control plane function on the SM policy based on a roaming status of the computing device associated with the one or more users; and
determine if the communication between the computing device and the AF exists based on validation of the one or more predefined rules and the roaming status of the computing device.
